(19) United States
(12) Patent Application Publication
(10) Pub. No.: US 2005/0226786 A1
(43) Pub. Date: Oct. 13, 2005

(54) Multi-well apparatus

(76) Inventors: David Clarence Hager, San Francisco, CA (US); Jeffrey D. Donaldson, Tigard, OR (US); Patrick Kearney, San Francisco, CA (US); Douglas O. Keller, Lake Oswego, OR (US); James William Leahy, San Leandro, CA (US); Robert D. Mercer, Cornelius, OR (US); Michael Morrissey, Danville, CA (US); Troy M. Swartwood, Seattle, WA (US)

Correspondence Address: PATENT DEPT;EXELIXIS, INC., 170 HARBOR WAY, P.O. BOX 511, SOUTH SAN FRANCISCO, CA, 94083-0511, US

(21) Appl. No.: 10/797,978

(22) Filed: Mar. 10, 2004

Related U.S. Application Data
(63) Continuation-in-part of application No. 10/094,253, filed on Mar. 8, 2002, now Pat. No. 6,852,290.
(60) Provisional application No. 60/274,262, filed on Mar. 8, 2001.

(51) Int. Cl. B01L 3/00; G01N 1/00

(52) U.S. Cl. 422/102; 422/99; 436/174

(57) ABSTRACT

A multi-well assembly according to one embodiment comprises a multi-well block and a guide plate. The multi-well block defines a plurality of wells, with each well having a fluid-impermeable bottom surface. The guide plate defines a plurality of fluid passageways corresponding to the wells of the multi-well block. The guide plate is configured such that, whenever the guide plate is registered with the multi-well block, fluid communication is established between each well and an associated fluid passageway. The guide plate enables iterative chemical or biological processes using multiple multi-well blocks. A seal plate is configured to cut fluid communication conferred by the guide plate via registration with the guide plate, or via registration with the multi-well block (once the guide plate is removed). The seal plate allows iterative chemical or biological processes within a single multi-well block.

### CROSS-REFERENCE TO RELATED APPLICATION

This application is a continuation-in-part claiming priority to U.S. Non-provisional application Ser. No. 10/094,253, filed on Mar. 8, 2002; which in turn claims priority to U.S. Provisional Application No. 60/274,262, filed on Mar. 8, 2001.

### FIELD

The present invention concerns multi-well apparatus, typically useful for chemical, biological and biochemical analysis.

### BACKGROUND

In recent years, various areas of research have demanded cost-effective assays and reactions of diminishing scale, increasing efficiency and accuracy, with high-throughput capacity. Multi-well devices with multiple individual wells, such as multi-well plates or multi-well blocks, are some of the most commonly used tools to carry out such reactions and assays. A variety of multi-well arrangements, constructed according to standardized formats, are commercially available. For example, a multi-well device having ninety-six depressions or wells arranged in a 12×8 array is a commonly used arrangement. Conventional multi-well devices may have wells with either fluid-impervious bottom surfaces to retain matter in the wells or open bottoms, in which case a receptacle plate may be placed underneath the multi-well device to collect matter flowing from the wells.

Test plates for numerous applications are well-known in the art. For example, test plates are known for use in culturing tissue samples. Other forms of test plates are adapted for carrying out chemical reactions or for use in micro-chromatography.

For applications requiring filtration, respective filters may be positioned in the wells of a multi-well device. In such applications, vacuum or pressure may be applied to facilitate filtration of fluid samples in the wells of the device. Following filtration, the fluids may be collected in individual containers or wells of a receptacle plate.

Despite these prior inventions, there exists a continuing need for new and improved multi-well apparatus and methods for their use.

### SUMMARY

The present invention is directed toward aspects and features of a multi-well assembly for use in, for example, chemical, biological, and biochemical analysis.

A multi-well assembly according to one representative embodiment comprises a multi-well block and a guide plate. The multi-well block has a plurality of wells, with each well having a fluid-impermeable bottom surface. The guide plate defines a plurality of fluid passageways corresponding to the wells of the multi-well block. The guide plate is configured such that, whenever the guide plate is registered with the multi-well block, fluid communication is established between each well and an associated fluid passageway.

In an illustrated embodiment, the guide plate has a plurality of projections corresponding to the wells of multi-well block. The projections are configured to perforate the bottom surfaces of respective wells whenever the guide plate is registered with the multi-well block to allow the contents (e.g., chemicals) of each well to flow outwardly, such as under the force of gravity, through the perforated bottom surfaces of the wells and into respective fluid passageways. The fluid passageways in a disclosed embodiment comprise channels extending substantially longitudinally through the guide plate and each projection.

The multi-well assembly also may include a second multi-well block (also termed a “receptacle” block) for receiving or collecting the contents of the wells of the multi-well block. The receptacle block in particular embodiments has a plurality of wells, each of which corresponds to a respective fluid passageway of the guide plate. Thus, whenever the receptacle block is registered with the guide plate and the multi-well block, a fluid path is defined between each well of the multi-well block, a respective fluid passageway of the guide plate, and a respective well of the receptacle block. An optional cover may be provided for covering the open tops of the wells of the multi-well block.

According to another representative embodiment, a multi-well assembly comprises a first plate and a second plate. The first plate has a plurality of wells. The second plate has a plurality of upwardly extending fluid conduits, each of which is adapted to receive the contents of a well whenever the first plate is registered with the second plate. In addition, the fluid conduits may be configured such that, whenever the first plate is registered with the second plate, each fluid conduit extends upwardly into the lower portion of a respective well to receive fluid therefrom. In particular embodiments, the fluid conduits comprise projections formed with substantially longitudinally extending passageways. The second plate also may be provided with an upwardly extending wall circumscribing each fluid conduit. The walls are configured such that, whenever the first plate is registered with the second plate, each wall matingly fits around the lower portion of a respective well to minimize cross-contamination between adjacent wells.

In another representative embodiment, a multi-well device includes a plurality of wells, with each well having a fluid-impervious lower surface. A guide tray has a plurality of fluid passageways that correspond to the wells of the multi-well device. The guide tray also has means for fluidly connecting each fluid passageway with a corresponding well whenever the guide tray is registered with the multi-well device.

According to yet another representative embodiment, a guide plate for use with a multi-well device comprises a body having upper and lower major surfaces. A plurality of projections depend from the upper major surface and a plurality of outlet spouts depend from the lower major surface below the projections. Extending through each projection and outlet spout is a fluid passageway or channel. In a disclosed embodiment, an upwardly extending wall surrounds each projection and is configured to matingly fit around the lower portion of a well of the multi-well device whenever the guide plate is registered with the multi-well device. In addition, each projection may be formed with a cutting surface that is configured to perforate the bottom surface of a well whenever the guide plate is registered with the multi-well device.

According to another representative embodiment, a guide plate for use with a multi-well device comprises a body having first and second major surfaces. A plurality of projections depend from one of the first and second major surfaces. Each projection is configured to perforate the bottom surface of a well of the multi-well device whenever the guide plate is registered with the multi-well device. In particular embodiments, the projections are shaped in the form of an ungula (i.e., a cylindrical or conical section formed by intersecting a cylinder or cone with one or more planes oblique to its base) and may be formed with a longitudinally extending channel.

In another representative embodiment, a method of carrying out multiple chemical reactions comprises providing a multi-well device having a plurality of wells with fluid-impervious bottom surfaces and a guide plate defining a plurality of passageways corresponding to the wells. Reagents for the chemical reactions may be introduced into the wells of the multi-well device. Upon completion of the chemical reactions, the guide plate may be registered with the multi-well device so that the bottom of each well is in flow-through communication with a passageway in the guide plate. Thus, the products of the chemical reactions are permitted to flow through the passageways and, if a receptacle plate is provided, into corresponding wells of the receptacle plate.

As described above, in some embodiments, the bottom surfaces of a plurality of wells of a multi-well block are perforated (or pierced), via a guide plate comprising cutting projections and corresponding fluid outlets, in order to establish fluid-communication between each of the plurality of wells and each of a corresponding plurality of receiving wells of a receptacle block. According to another exemplary embodiment, the multi-well apparatus of the invention comprises a seal plate, for sealing (substantially stopping all fluid communication from) a plurality of the perforated wells of the multi-well block or a plurality the outlets of the guide plate.

In one exemplary embodiment, the seal plate seals all perforated wells of the multi-well block or flow-through via the guide plate (via its fluid outlets), when registered with the multi-well block or the guide plate, respectively. The seal plate comprises a body having upper and lower major surfaces. The upper major surface comprises a plurality of sealing elements, each configured to stop fluid communication conferred by the guide plate, either by sealing the perforation or an outlet of the guide plate, when the seal plate is registered with the multi-well block or guide plate, respectively. Sealing elements can include wells that circumscribe at least a portion of a perforated well or fluid outlet, septum (preferably pliable and soft) that matingly seal with any fluid passageway or perforation, protrusions that enter and block perforations or fluid-outlets, hot melt sealing elements (e.g. via melting fluid outlet materials shut), pinching or crimping elements, and the like.

In one preferred embodiment, the upper major surface comprises a plurality of orifices, each defining the opening of a plurality of fluid impermeable wells. The plurality of orifices can be substantially coincident with the upper major surface of the seal plate, or alternatively each orifice substantially defines the opening of each of a plurality of upwardly extending channels depending from the upper major surface, each channel forming a portion of each fluid impermeable well. The channels typically, but not necessarily extend through the seal plate, depending from the lower major surface, and end with a bottom surface, thus forming the fluid impermeable well.

When the seal plate is registered with either the multi-well block or the guide plate, each of said plurality of fluid impermeable wells surrounds (e.g. via an upper portion of the inner surface of said channel), and forms a substantially fluid impermeable seal with, either a corresponding lower portion of each of the plurality of wells of the multi-well block or a corresponding fluid outlet or lower wall (circumscribing the fluid outlet) of the guide plate, respectively.

Also in some embodiments, the seal plate can also mate with itself; that is for example, once a guide plate is mated with a seal plate (and thus perforates the wells of the seal plate) the guide plate can be removed and a new un-perforated seal plate can be mated with the perforated seal plate.

Preferably, the bottom surface of each well of the seal plate is comparable to the bottom surface of each of the plurality of wells of the multi-well block; that is, the bottom surface is perforable, at least by the guide plate as described above.

Yet another aspect of the invention are methods of performing iterative chemical or biological processes in a multi-well block. Such methods can be characterized by the following aspects: a) performing a first chemical or biological process in a plurality of wells of a multi-well block, b) perforating the lower portion of a plurality of wells of the multi-well block, c) removing a fluid portion of the contents of each of the plurality of wells, while a solid portion of the contents of each of the plurality of wells remains, d) sealing the plurality of wells, and e) performing a second chemical or biological process in the plurality of wells. In one preferred embodiment, such methods are performed using all wells of the multi-well block. In another preferred embodiment, such methods are used to carry out more than two chemical or biological processes. In yet another preferred embodiment, such methods are performed using the multi-well block, guide plate, and seal plate of the invention. In still yet another preferred embodiment, successive mating of guide plate to multi-well block, seal plate to previously mated guide plate, and guide plate to previously mated seal plate is performed for such methods.

In other methods of the invention, combinations of multi-well block, guide plate, seal plate, and receptacle blocks are used to perform processes that comprise iterative chemical or biological operations in a single block and chemical or biological operations in separate multiple blocks.

These and other features of the invention will be more fully appreciated when the following detailed description of the invention is read in conjunction with the accompanying drawings.

### BRIEF DESCRIPTION OF THE DRAWINGS

FIG. 1 is a perspective view of a multi-well assembly, according to one embodiment, shown with a portion of the upper multi-well block broken away to show the upper surface of the guide plate, and with a portion of the guide plate broken away to show the wells of the lower multi-well block.

FIG. 2 is a side elevation view of the upper multi-well block of the multi-well assembly of FIG. 1, shown with a cover covering the open tops of the wells.

FIG. 3 is a perspective, sectional view of the upper multi-well block of FIG. 1.

FIG. 4 is a bottom perspective view of the upper multi-well block of FIG. 1.

FIG. 5 is a vertical section of the multi-well assembly of FIG. 1, shown with a cover installed on the upper multi-well block and filters positioned in each well.

FIG. 6 is a top perspective view of the guide plate of the multi-well assembly of FIG. 1.

FIG. 7 is an enlarged perspective view of a portion of the guide plate shown partially in section.

FIG. 8 is an enlarged perspective view of a portion of the upper multi-well block, shown partially in section, and a portion of the guide plate, shown partially in section, in which the wells of the upper multi-well block are registered with corresponding fluid conduits of the guide plate.

FIG. 9 is a perspective view of the cover of FIG. 2.

FIG. 10 is a top perspective of a seal plate of the invention.

FIG. 11 is a bottom perspective of a seal plate of the invention.

FIG. 12 is a cut-away side view of a seal plate of the invention.

FIG. 13 is a flow chart depicting aspects of an embodiment of a method of the invention.

FIG. 14 is a flow chart depicting aspects of a process of the method depicted in FIG. 13.

### DETAILED DESCRIPTION

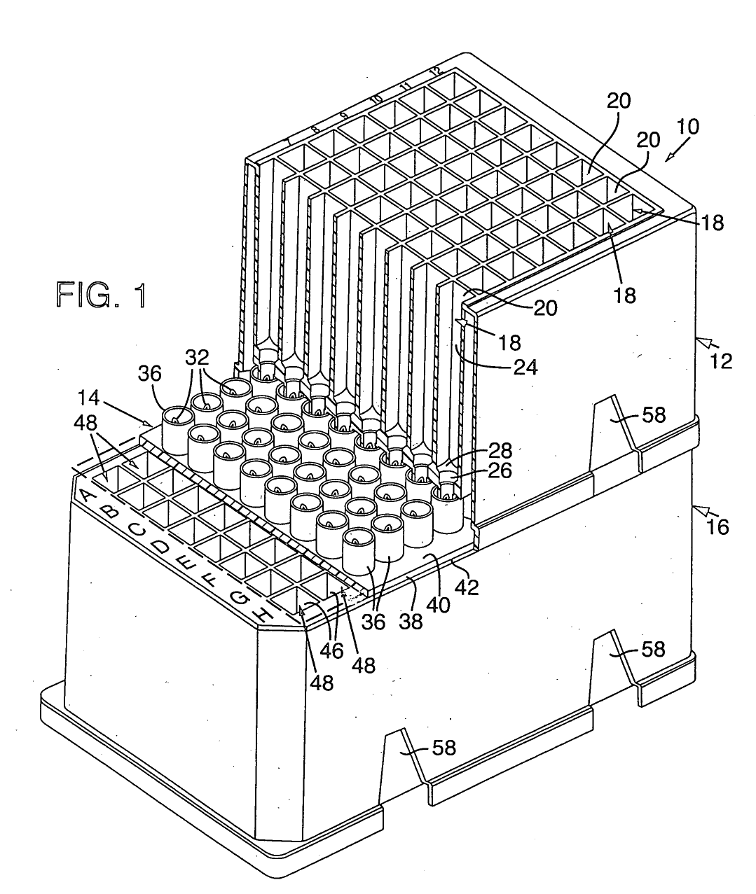

Referring initially to FIG. 1, there is shown a multi-well assembly, indicated generally at 10, according one embodiment. Generally, the assembly 10 comprises a first multi-well block 12, a guide plate, or tray, 14 situated below the first multi-well block 12, and a second multi-well block 16 (also termed a “receptacle block”) situated below the guide plate 14. In use, chemical or biological matter is introduced into the first multi-well block 12 for carrying out any of various chemical, biological, and biochemical reactions and processes. The second multi-well block 16 serves as a receptacle block for receiving chemical or biological matter from the first multi-well block 12, as described in greater detail below.

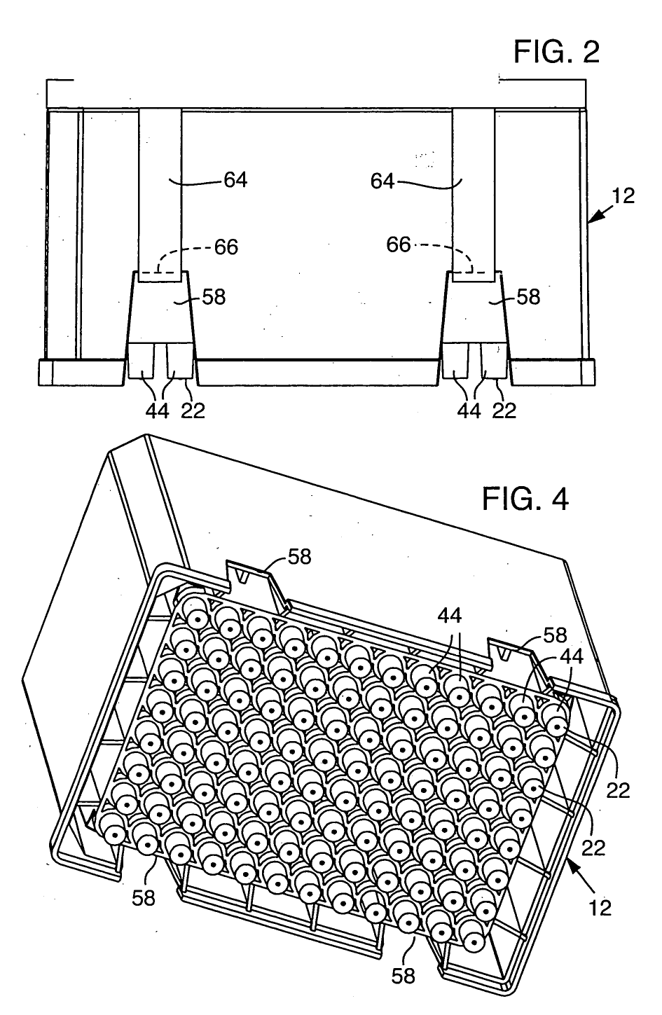

Referring also to FIGS. 2-4, the first multi-well block 12 in the illustrated configuration has, as its name suggests, a generally rectangular block-like shape and supports a 8×12 array of vertically disposed, elongated wells, or cavities, 18. Such a 96-well array, with specific (i.e., 9 mm) center-to-center spacing is a standard configuration for many commercially available multi-well test plates. The overall dimensional area of the first multi-well block 12, as well as the guide plate 14 and the second multi-well block 16, provide for a footprint of the same size as a standard 96-well plate to permit use with standard equipment holders, well washers, and the like.

Although in the illustrated embodiment the first multi-well block 12 is shown as having a generally block-like shape, the first multi-well block 12 may be generally cylindrical in shape or have any of various other geometric shapes. In addition, any number of wells 18 and any arrangement of wells 18 may be used. For example, without limitation, other possible arrays of wells 18 include a 4×6 array and a 6×8 array. Although less desirable, in other embodiments, the first multi-well block 12 may support wells 18 that are not arranged in an ordered array. In still other embodiments, wells that are substantially shallower in depth than those of the illustrated embodiment may be used, in which case the first multi-well block 12 will have more of a plate-like configuration, rather than the illustrated block-like shape. The wells 18 may be configured to support volumes, for example, from about 100 μL to several mL per well, although wells having a larger or smaller volumetric capacity also may be used. In working embodiments, the wells 18 are configured to hold about 2 mL to 3 mL per well.

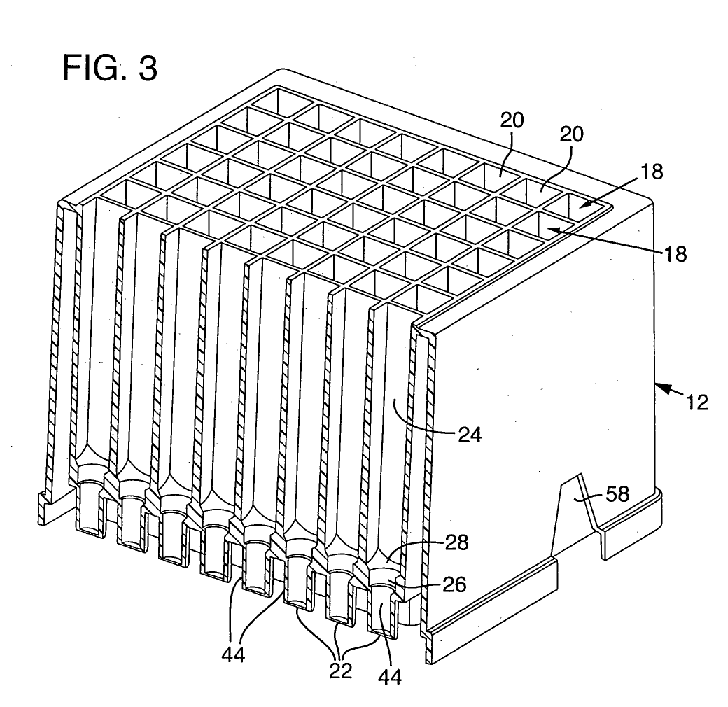

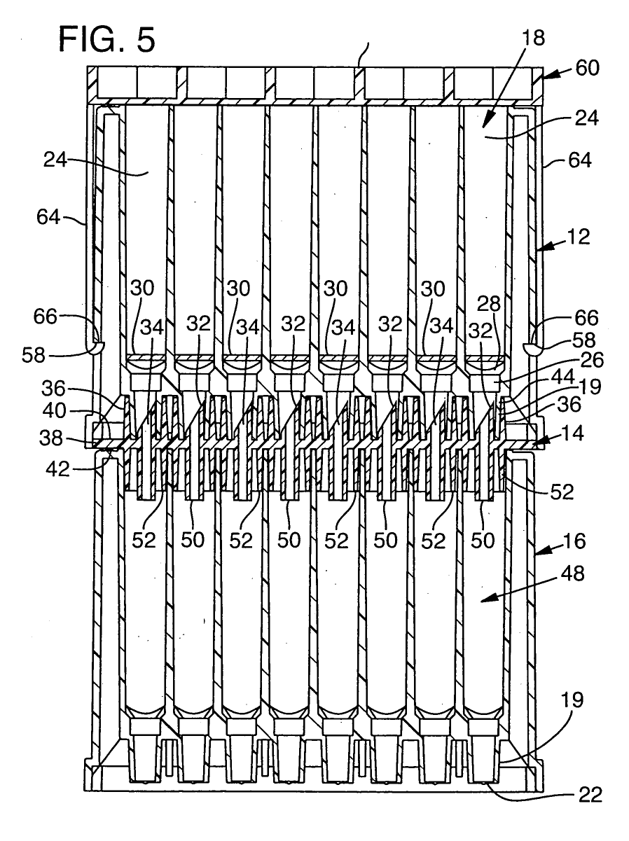

The illustrated wells 18 have open tops 20 (FIGS. 1 and 3) and fluid-impermeable barriers 22 (FIGS. 3 and 4) that serve as bottom surfaces for the wells 18. As best shown in FIGS. 3 and 5, each well 18 has a generally rectangular (in the vertical direction) upper portion 24, a cylindrical intermediate portion 26, and a cylindrical lower portion 44. As shown, the upper portion 24 and lower portion 44 of each well 18 may be slightly tapered so that their cross-sectional profile exhibits decreasing width from top to bottom. The lower end of each lower portion 44 is covered or sealed by the respective fluid barrier 22 (FIGS. 2 and 4). In addition, as shown in FIGS. 3 and 5, the upper portion 24 of each well 18 may be formed with a curved bottom surface 28 to facilitate settling of any solid material in well 18 more generally in the central region of curved bottom surface 28. In alternative embodiments, the well 18 may have any of various other configurations. For example, an upper portion 24 may have a circular transverse cross-section or square-shaped transverse cross-section with rounded corners. Alternatively, the wells 18 may be provided with a constant cross-sectional shape along their entire lengths.

In addition, in still other embodiments, the barriers 22 may be displaced upward from the bottom edges of the lower portions 44. For example, the barriers 22 may be positioned within the intermediate portions 26 or the lower portions 44 of the wells 18. In any event, the barriers 22 serve to retain matter (e.g., chemicals) introduced into the respective wells 18.

The barriers 22 desirably are about 0.005 to 0.015 inch thick, with 0.010 inch being a specific example, although thinner or thicker barriers 22 can be used. In other embodiments, the barriers 22 may have a variable thickness. For example, a barrier 22 may have a convex shape so that its thickness is greatest at its center, or alternatively, a concave shape so that its thickness is greatest at its periphery.

Referring to FIGS. 2, 5, and 9, an optional cover or lid 60 may be provided for covering the open tops 20 of the wells 18. The cover 60 in the configuration shown comprises a fluid-impermeable top portion 62 and legs 64 that extend downwardly from opposing sides of the top portion 62. The bottom of each leg 64 forms an inwardly extending latch 66 that is dimensioned to fit within a corresponding notch 58 defined in a side of the first multi-well block 12 (FIGS. 2 and 5). The legs 64 desirably are made from a semi-flexible material to permit slight bending or flexing of the legs 64 when installing or removing the cover 60. A sealing member, such as a flat gasket (not shown), may be positioned between the open tops 20 and the cover 60 to ensure a fluid-tight seal. To remove the cover 62, the bottom ends of legs 64 are pulled away from the sides of the multi-well block 12 until the latch portions 66 are removed from their associated notches 58, at which point the cover 62 can be lifted away from the multi-well block 12.

Referring again to FIG. 1, the second multi-well block 16, like the first multi-well block 12, has an ordered array of wells 48, each corresponding to a respective well 18 of the first multi-well block 12. The guide plate 14 is configured to direct the flow of matter from the wells 18 of the first multi-well block 12 to corresponding wells 48 of the second multi-well block 16, as described below. In the illustrated embodiment, the second multi-well block 16, has the same construction as the first multi-well block 12, however, this is not a requirement. For example, if the first multi-well block 12 and the guide plate 14 conform to a standardized format, such as the illustrated 96-well format, any suitable commercially available receptacle block may be used in lieu of the illustrated second multi-well block 16.

Referring to FIGS. 5-8, the guide plate 14, in the illustrated configuration, comprises a body 38 having an upper major surface 40 and a lower major surface 42. The guide plate 14 has an ordered array of upwardly extending fluid conduits in the form of projections 32, each of which corresponds to a respective well 18 of the first multi-well block 12. The guide plate 14 also may have an ordered array of downwardly extending outlet spouts 50 located below respective projections 32. The guide plate 14 is formed with respective bores, or channels, 34 extending through each projection 32 and outlet spout 50.

The projections 32 are configured to perforate the respective barriers 22 to allow the contents of each well 18 to flow outwardly therefrom whenever guide plate 14 is registered with the first multi-well block 12 (as shown in FIGS. 5 and 8). As used herein, to “register” the guide plate 14 with the first multi-well block 12 means to align each projection 32 with the respective barrier 22 of a corresponding well 18 and to press together the guide plate 14 and the first multi-well block 12 until the projections 32 extend into the respective lower portions 44 of the wells 18. Likewise, the second multi-well block 16 can be registered with the guide plate 14 by aligning the open tops of the wells 48 with corresponding outlet spouts 50 of the guide plate 14 and pressing the guide plate 14 and the second multi-well block 16 together so that the outlet spouts 50 extend into the respective wells 48 (FIG. 5).

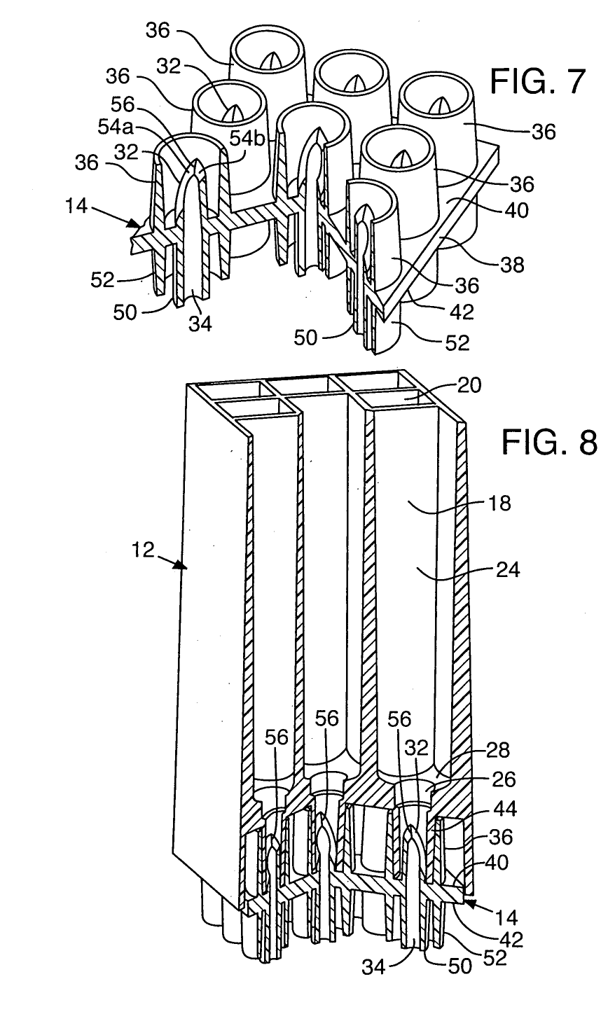

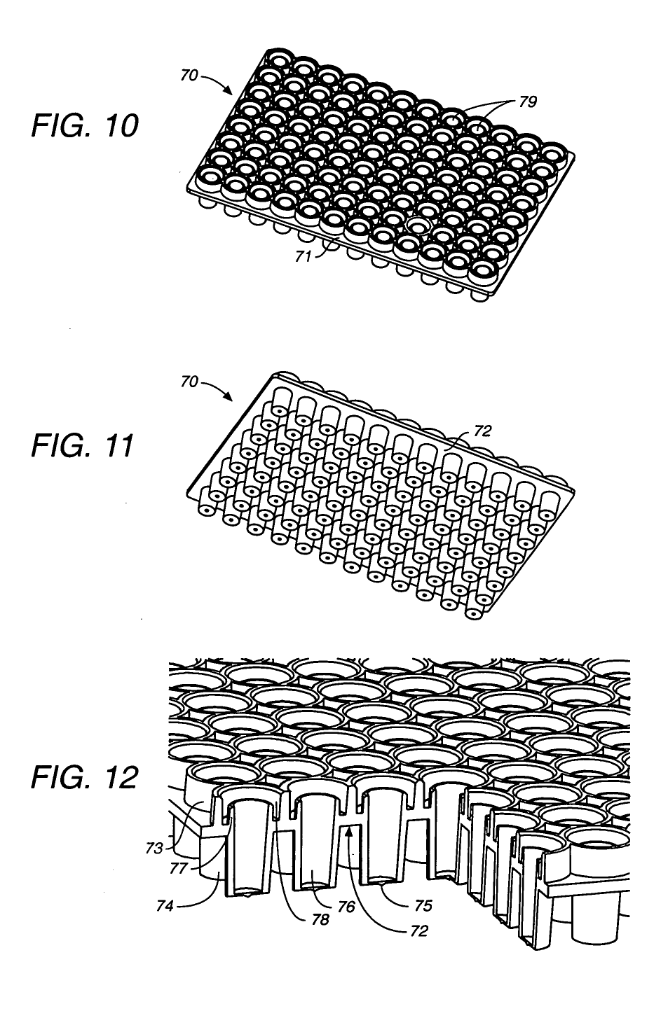

As best shown in FIG. 7, the shape of each projection 32 in the illustrated embodiment is that of a cylindrical section formed by intersecting a cylinder with two planes oblique to the base of the cylinder in the manner shown. Thus, two flat, upwardly angled surfaces, 54a and 54b, are provided that converge at the top, or crest, of the projection 32 to form a cutting edge 56. The cutting edge 56 is positioned to cut through a respective barrier 22 whenever the guide plate 14 and the first multi-well block 12 are pressed together. Other forms for the projections 32 alternatively may be used. For example, the projections 32 may be shaped in the form of a cone, a cylinder, or any variation thereof, and may or may not be provided with a cutting edge, such as shown in FIG. 7, to facilitate perforation of the barriers 22.

In alternative embodiments, the barriers 22 may be coupled to the lower portions 44 of the wells 18 in a manner that allows the barriers to be removed from sealing the bottom of their respective wells 18 without being perforated or otherwise damaged whenever the guide plate 14 is registered with the first multi-well block 12. For example, a barrier 22 may be hingedly connected to a lower portion 44 such that the barrier 22 remains in a normally closed position for retaining the contents of the well 18 whenever the first multi-well block 12 is not registered with the guide plate 14. The hinged barrier 22 is caused to move to an open position by a respective projection 32 to permit the contents of the well 18 to escape therefrom whenever the first multi-well block 12 is registered with the guide plate 14. The barrier 22 in this configuration may be biased toward its normally closed position so that it automatically closes or seals the lower portion 44 whenever the guide plate 14 is detached from the first multi-well block 12.

In another embodiment, a barrier 22 may be configured such that it is normally biased in a closed position and is caused to move upwardly through a lower portion 44 by a respective projection 32 whenever the first multi-well block 12 is registered with the guide plate 14. In this configuration, the lower portion 44 is tapered from top to bottom so that an opening is created between the periphery of the barrier 22 and the inner surface of the lower portion 44 as the barrier is moved in an upward direction by the respective projection 32.

In the embodiment shown in FIGS. 5-8, each projection 32 is circumscribed by an upper wall 36 depending from the upper major surface 40 of the guide plate 14. Each outlet spout 50 is similarly circumscribed by a lower wall 52 depending form the lower major surface 42. As shown in FIGS. 5 and 8, whenever the guide plate 14 is registered with the first multi-well block 12, each upper wall 36 of the guide plate 14 matingly fits around the lower portion 44 of a corresponding well 18. This provides for a substantially fluid-tight passageway extending between each well 18 and corresponding channel 34 to substantially reduce cross-contamination between adjacent wells 18. In addition, each lower wall 52 is dimensioned to fit within an open top 46 of a corresponding well 48 of the second multi-well block 16. Thus, whenever the first multi-well block 12, the guide plate 14, and the second multi-well block 16 are assembled in the manner shown in FIG. 5, the contents of each well 18 of the multi-well block 12 are allowed to flow through the channels 34 of the guide plate 14 into corresponding wells 48 of the receptacle block 16.

Guide-plate and projection configurations other than the illustrated configurations also may be used. For example, in alternative embodiments, one or more channels may be formed in the guide plate 14 in the space between each projection 32 and its respective upper wall 36, rather than through the projections 32 themselves, to permit the contents of the wells 18 to flow through the guide plate 14 whenever the guide plate 14 is registered with the first multi-well block 12. In still other embodiments, the upper walls 36 are dimensioned to be inserted into respective lower portions 44 of the wells 18.

As shown in FIG. 5, optional filters 30 may be positioned within the wells 18 of the first multi-well block 12 to filter chemicals or other matter introduced into the wells 18. Alternatively, filters (not shown) can be positioned in the channels 34 of the guide plate 14 and/or in the wells 48 of the second multi-well block 16. The filters 30 may comprise any suitable material, such as, for example, polypropylene, polyethylene, glass fiber, and the like.

The first multi-well block 12, the guide plate 14, the second multi-well block 16, and the cover 60 desirably are formed of a substantially rigid, water-insoluble, fluid-impervious material that is chemically non-reactive with the matter to be introduced into the multi-well assembly 10. The term “substantially rigid” as used herein is intended to mean that the material will resist deformation or warping under light mechanical or thermal load. Suitable materials include, without limitation, polystyrene, polyethylene, polypropylene, polyvinylidine chloride, polytetrafluoroethylene (PTFE), polyvinyledenefluoride (PVDF), glass-impregnated plastics, and stainless steel, among others. In working embodiments, polypropylene is used because it is easily amenable to varying temperature and pressure conditions, and is easy to fabricate.

The first multi-well block 12, the guide plate 14, the second multi-well block 16, and the cover 60 may be formed by any suitable method. For example, using conventional injection-molding techniques, each component of the assembly 10 (i.e., the first multi-well block 12, the guide plate 14, the second multi-well block 16, and the cover 60) can be formed as a unitary structure. In an alternative approach, various parts of each component may be formed and bonded together using conventional thermal-bonding techniques. For example, the wells 18 and/or the barriers 22 can be separately formed and subsequently thermally bonded together to form the first multi-well block 12.

The multi-well assembly 10 may be used in any of various chemical, biological, and biochemical reactions and processes such as, without limitation, solution-phase or solid-phase chemical synthesis and reactions, protein-derivitization assays, protein-caption assays, biotinylation and fluorescence labeling assays, magnetic separation assays, chromatography, and culturing of microorganisms, among others. The processes in the assembly 10 may be carried out at room temperature, below room temperature, or above room temperature. In addition, the assembly 10 supports multiple simultaneous reactions.

In using the multi-well assembly 10 for, for example, carrying out multiple chemical reactions, reagents are introduced into the wells 18 of the first multi-well block 12, using, for example, a multi-channel pipette. In this manner, the first multi-well block 12 serves as a “reaction block” for carrying out the multiple chemical reactions. As previously mentioned, the barriers 22 serve to retain the reagents in the wells 18 during the reaction step. If desired, the cover 60 may be placed on the first multi-well block 12 to prevent the escape of gases through the open tops 20 of the wells 18 as the reactions occur, and/or to prevent contamination or cross-contamination of the reactions.

Upon completion of the reaction step, the bottom of each well 18 is mated and coaxially aligned with a respective upper wall 36 of the guide plate 14, and each well 48 of the second multi-well (receptacle) block 16 is mated and aligned with a respective lower wall 52 of the guide plate 14. The first multi-well block 12, the guide plate 14, and the receptacle block 16 may then be placed in a conventional pressing apparatus (not shown). The pressing apparatus is operated to press the assembly together to cause the projections 32 to perforate the respective barriers 22, thereby allowing the reaction products in each well 18 to flow through the channels 34 of the guide plate 14 and into the respective wells 48 of the receptacle block 16 for analysis and/or storage.

In specific working embodiments, the assembly 10 is configured such that about 5 lb to 15 lb of force per well 18 during pressing is sufficient to cause the projections 32 to perforate the barriers 22, although this is not a requirement. In other embodiments, the assembly 10 may be configured to allow a user to register the first multi-well block 12, the guide plate 14, and the receptacle block 16 without the use of a pressing apparatus.

After pressing, conventional techniques may be used to facilitate removal of the contents of the wells 18. For example, the assembly 10 may be centrifuged, or a pressure differential may be created across the assembly 10, as well known in the art. A pressure differential may be created by, for example, applying positive pressure from a compressed-gas source (e.g., compressed air) to the wells 18 of the first multi-well block 12 or, alternatively, applying a vacuum to the wells 48 of the receptacle block 16.

After the reaction products are removed from the receptacle block 16, the assembly 10 may be cleaned and re-used in another process. If desired, the bottom of the wells 18 may be re-sealed by, for example, welding a mat of suitable material (e.g., polypropylene) to the bottom of the wells 18. Otherwise, the first multi-well block 12 may be used as is, that is, without any barriers 22 in place to retain matter introduced into the wells 18.

In addition, in other methods of use, after executing a first reaction step, the receptacle block 16 may be used to perform a subsequent reaction or processing step, and additional chemicals or reagents may be introduced into the wells 48. Thereafter, the receptacle block 16 can be registered with another guide plate 14 and receptacle block 16 in the manner described above. In this manner, the receptacle block 16 is used as a reaction block in the subsequent reaction or processing step.

As described above, according to another exemplary embodiment, the multi-well apparatus of the invention comprises a seal plate, for sealing perforated wells of a multi-well block or outlets of the guide plate. As mentioned, the seal plate can also seal the perforated wells of another seal plate, if desired. In most preferred embodiments the seal plate is used to reseal either perforated wells of a multi-well block or the fluid outlets of a guide plate. Preferably but not necessarily, the seal plate is configured so that it seals all perforated wells of the multi-well block or all fluid outlets of the guide plate, when registered with the multi-well block or the guide plate, respectively. For simplicity and economy in design and manufacture, in one embodiment, the seal plate is configured to mate with the guide plate, and not necessarily also the multi-well block or another seal plate.

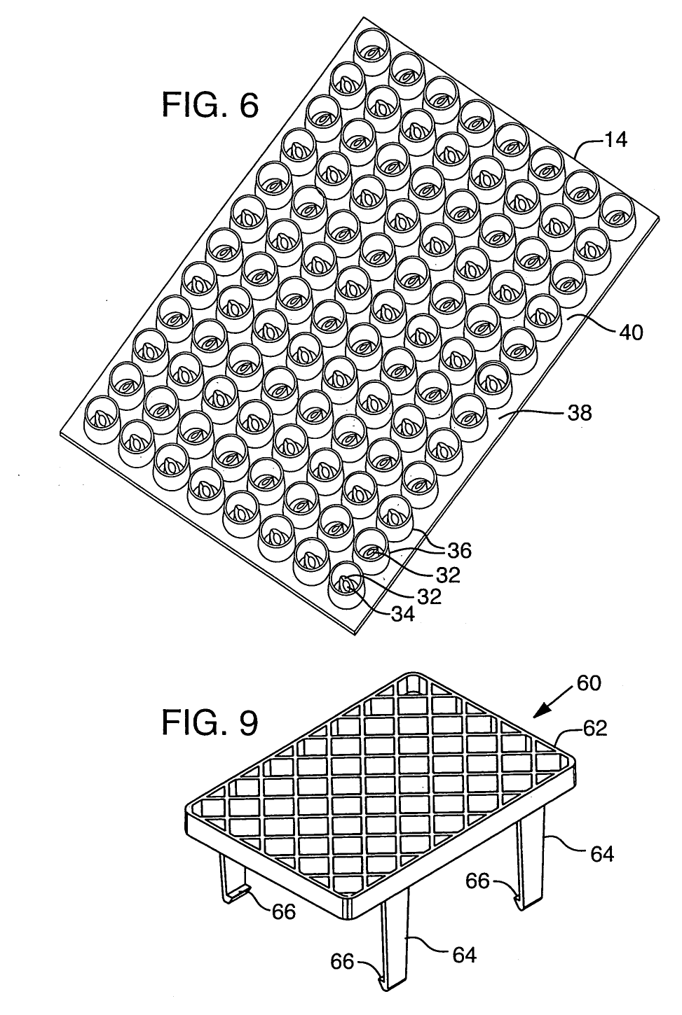

Referring to FIG.'s 10, 11, and 12, an exemplary seal plate, 70, of the invention is depicted in various ways. Seal plate 70 comprises a body having upper and lower major surfaces, 71 and 72, respectively. Upper major surface 71 comprises a plurality of orifices 79. Each of the plurality of orifices 79 defines the opening of a well 76. Each well 76 has an inner surface which is substantially fluid impermeable. The bottom surface 75 of each well is perforable, for example by cutting edges 22 of the projections 32 of guide plate 14, when the guide plate 14 is registered with seal plate 70 (refer to FIG. 6). In this example, each orifice 79 resides at the opening of each of a plurality of upwardly extending channels 77 depending from upper major surface 71 and lower major surface 72. Thus, well 76 comprises orifice 79, channel 77, and bottom surface 75.

In this particular example, there is another wall 73, circumscribing and extending beyond the portion of channel 77 that extends beyond upper major surface 71. Between inner surface 78 of wall 73 and the outer surface of channel 77, there is a space for accepting lower wall 52 of guide plate 14 (refer to FIG. 7). Orifice 79 is dimensioned to accept outlet spout 50 of guide plate 14 (again refer to FIG. 7). In some embodiments, the inner dimension of wall 73 accepts the lower portion 44 of well 18 of multi-well block 12 (refer to FIG. 3). Thus when seal plate 70 is registered with either multi-well block 12 or guide plate 14, each of said plurality of orifices 79 (and upper portion of the inner surface of channel 77) surrounds, and forms a fluid-tight seal with, either a corresponding lower portion of each of the plurality of wells of the multi-well block or a corresponding fluid outlet of the guide plate, respectively. In other embodiments, when seal plate 70 is registered with either multi-well block 12 or guide plate 14, each of the inner surfaces of wall 73 surrounds, and forms a fluid-tight seal with, either a corresponding lower portion of each of the plurality of wells of the multi-well block or a corresponding fluid outlet of the guide plate, respectively.

Preferably, a dual seal is formed. For example, in a particularly preferred embodiment, when the seal plate 70 is mated with guide plate 14, the inner surface of wall 73 mates with the outer surface of lower wall 52 of the guide plate to make a first fluid-tight seal, and the upper portion of the inner surface of channel 77 mates with the outer surface of fluid outlet 50 of the guide plate when the outlet is inserted into orifice 79.

As described for multi-well block 12 and guide plate 14, seal plate 70 preferably is formed of a substantially rigid, water-insoluble, fluid-impervious material that is chemically non-reactive with the matter to be introduced into the multi-well assembly 10. Suitable materials include, without limitation, polystyrene, polyethylene, polypropylene, polyvinylidine chloride, polytetrafluoroethylene (PTFE), polyvinyledenefluoride (PVDF), glass-impregnated plastics, and stainless steel, among others. In working embodiments, polypropylene is used because it is easily amenable to varying temperature and pressure conditions, and is easy to fabricate. Seal plate 70 may be formed by any suitable method, for example, using conventional injection-molding techniques, as described above.

In a preferred embodiment, the bottom surface 75 of each well is comparable to the bottom surfaces 22 of each of the plurality of wells 18 of the multi-well block 12; that is, bottom surface 75 is perforable, at least by the guide plate as described above. Thus wells 76 of seal plate 70 are perforated by the projections of guide plate 14 when guide plate 14 is mated with seal plate 70, just as wells 18 of multi-well block 12 are perforated by the projections of guide plate 14 when guide plate 14 is mated with multi-well block 12. Preferably the wells of seal plate 70 are configured to minimize the volume created either between the seal plate well and the guide plate outlet, or between seal plate well and the bottom surface of the perforated well of the multi-well block. In some embodiments, a particular minimum volume is desired so that subsequent guide plate protrusions have sufficient space to reside after puncturing the bottom surface of the seal plate wells.

Analogous to guide plate 14 and multi-well block 12, in one embodiment seal plate 70 and multi-well block 12 are mated by pressing together. Also analogous to guide plate 14 and multi-well block 12, in one embodiment seal plate 70 and guide plate 14 are mated by pressing together. Thus seal plates of the invention provide means to cut fluid communication provided by perforation of the lower portions of wells of a multi-well vessel; either via direct registration with the multi-well block or indirectly via registration with the guide plate (itself registered to the multi-well block).

As mentioned above, yet another aspect of the invention is methods of performing iterative chemical or biological processes (for example as described above) in a multi-well block. Such methods can be characterized by the following aspects: a) performing a first chemical or biological process in a plurality of wells of a multi-well block, b) perforating the lower portion of the plurality of wells, c) removing a fluid portion of the contents of each of the plurality of wells, while a solid portion of the contents of each of the plurality of wells remains, d) sealing the plurality of wells, and e) performing a second chemical or biological process in the plurality of wells. In one preferred embodiment, such methods are performed using all wells of the multi-well block. In another preferred embodiment, such methods are used to carry out more than two chemical or biological processes. In yet another preferred embodiment, such methods are performed using the multi-well block, guide plate, and seal plate of the invention. In still yet another preferred embodiment, successive mating of guide plate to multi-well block, seal plate to guide plate, and guide plate to seal plate is performed during such methods. In other methods of the invention, other combinations of multi-well block, guide plate, seal plate, and receptacle block are used.

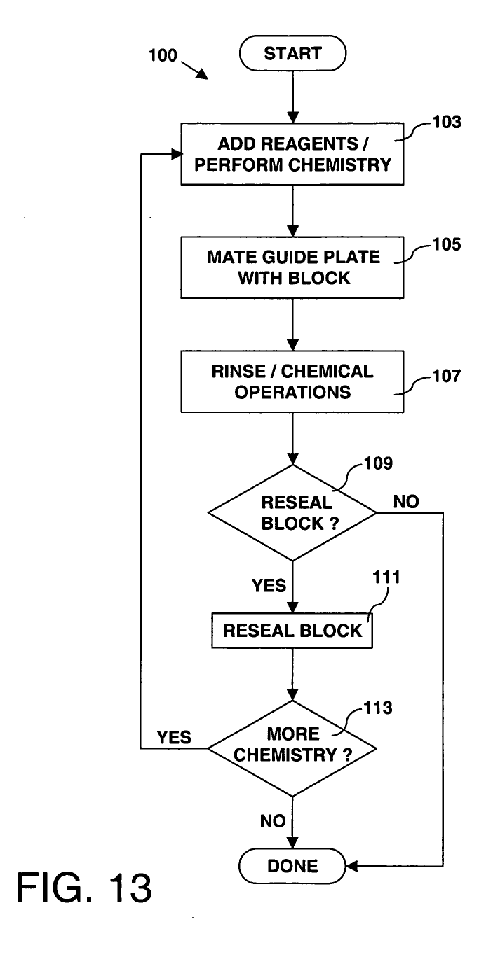

FIG. 13 is a flowchart outlining aspects of a method 100 of the invention. For convenience, method 100 is described in terms of using multi-well apparatus as described above in relation to FIG.'s 1-12. Methods of the invention are not so limited.

Method 100 begins with adding reagents to each well of multi-well block 12. See operation 103. In this example, the reagents can be chemical or biological reagents, as one of ordinary skill in the art would understand (examples are described in more detail above). In a preferred embodiment, the reagents include solid-phase reagents or reactants in a chemical reaction or some heterogeneous reaction where the filter 30 (refer to FIG. 5) can prevent solid material reagent, reactant, or product from leaving wells 18. Thus, in such embodiments, the desired products of the chemical reaction are solid or solid-bound (such as polymer-bound reagents), at least at some point during the method, such they can not pass through filter 30. For example, in some embodiments the reagents in the wells will be homogeneous, but a precipitating reagent is added in order to solidify the product for filtration or washing functions.

Once the reagents in wells 18 are in the appropriate form, specifically the desired material is in solid or solid-bound form as described above, then guide plate 14 is registered with multi-well block 12. This perforates the bottom surface of wells 18, thus establishing fluid communication therethrough. See operation 105. Next rinse or other desired chemical operations are performed, see operation 107. This can include rinsing desired solid material within wells 18 one or more times, or addition of a reagent to perform chemistry during a flow-through operation, such as adding a stop agent or blocking agent to modify desired residues on solid-phase beads.

Next, a decision is made whether or not to reseal the wells of multi-well block 12, see operation 109. In one embodiment of the invention, the decision is made not to reseal the block. For instance, the solid product in the wells may be dissolved and collected via rinsing through filter 30 and so on. Or the solid-bound product may be cleaved from its polymer resin and collected in liquid form as above. However, the invention allows for iterative chemical or biological processes to be performed in a single multi-well block. Therefore, if the answer to decision operation 109 is “yes” then the multi-well block is resealed (as described above for instance) using seal plate 70, see operation 111.

Next, a decision is made whether or not more chemistry is to be performed on the solid material remaining in wells 18, see operation 113. If the answer is “no,” for instance the resealed block may be stored with or without liquid medium added to wells 18), then the method is done. If “yes,” then the method returns to operation 103, where more chemical steps are performed. For example, solid-bound molecules can be further transformed into a desired intermediates or products. Operations 103-113 can be repeated iteratively until a desired product is obtained, and presumably a final step would include cleavage of the desired material from the solid-support (see operation 107). In another example, during operation 103, a non-solid bound solid material formed in the first iteration of operation 103 is re-dissolved in an appropriate solvent for more solution-phase chemical transformations in a second iteration of operation 103. During iterative performance of steps 103-113, desired materials can be precipitated, bound to solid-phase resins, and the like to keep them within wells 18 for further manipulation. Since the desired materials are solids and remain in the wells during rinsing, receptacle blocks need not necessarily be used to collect the rinsates. However preferably, to avoid cross contamination across the outlets of the guide plate, non-solid or non-solid-bound materials are removed via dissolving in an appropriate solvent and capture into a receptacle block, as described above. If no more chemical transformations or treatments are desired then the method is done, see operation 113.

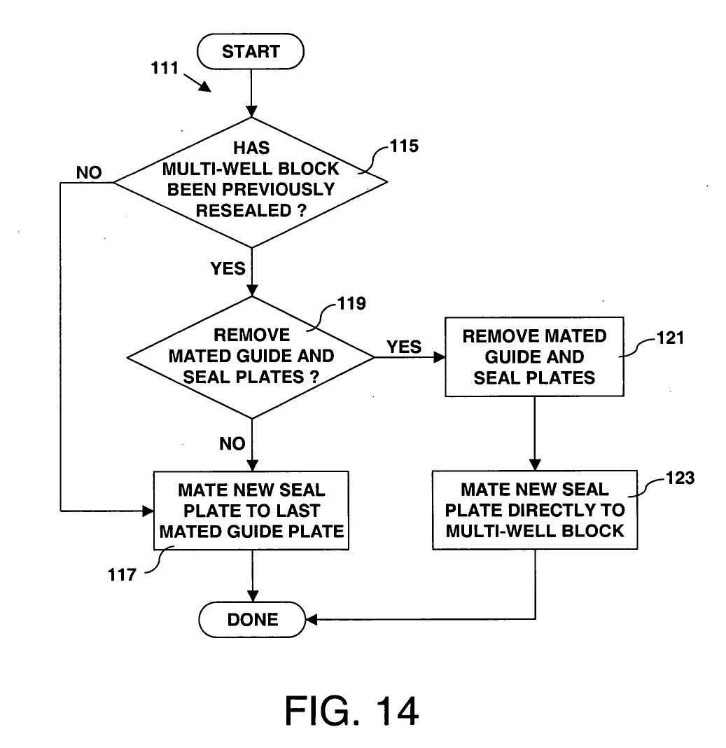

FIG. 14 is a flowchart depicting aspects of operation 111, according to FIG. 13, specifically the reseal operation and related logic. As described above, multi-well block 12, guide plate 14, receptacle block 16, and seal plate 70 can be used in various combinations, depending on the desired result. In one embodiment, the reseal operation can be performed by removing guide plate 14 from multi-well block 12, and then mating seal plate 70 with multi-well block 12. Alternatively, seal plate 70 is mated with guide plate 14 (having been already mated with multi-well block 12). Also, successive mating of guide plates and seal plates can achieve this goal (also, as mentioned above, two seal plates can mate with one another, but that is not necessarily preferred). Thus, reseal operation 111 starts with a decision whether or not multi-well block 12 has been previously resealed, see operation 115. If not, then a seal plate is mated with the guide plate already mated with the multi-well block, and the method is done, see operation 117. If the answer to 115 is “yes,” then a decision is made whether or not to remove guide and seal plates already mated with the multi-well block, see operation 119. If not, then a new seal plate is mated with the last guide plate added to the apparatus, and the method is done, see operation 117. If pre-attached guide and seal plates are to be removed, then the guide and seal plates (or at least the last seal plate) are removed, see operation 121.

Since the guide and seal plates “stack” with each other, any number of plates can be removed, or not, depending on the desired application. For example, as each successive guide plate and corresponding seal plate is added the effective volume of wells 18 are increased proportionately. This can be desirable in some instances, where more solvent is needed for subsequence chemical transformations. Again referring to FIG. 14, if all the guide and seal plates are removed, then seal plate 70 is mated directly to multi-well block 12, and the method is done, see operation 123. This latter result may be desirable when the volume of wells 18 is to be maintained substantially constant.

When considering whether or not to remove used guide plates 14 or seal plates 70 as described above, one consideration especially important is the number of steps to be carried out during a high-through put operation, such as in parallel organic synthesis using multi-well apparatus of the invention. Oftentimes parallel organic synthesis can take multiple steps, although minimization of these steps (and any mechanical manipulation steps) is desirable in a high-throughput regime. Although removal of used guide or seal plates does have utility, as described above, it does add extra steps to a process. Therefore in some embodiments, the guide and seal plates are not removed during iterative chemical or biological processes. When mated with multi-well block 12 or each other, guide plate 14 and seal plate 70 not only form a substantially fluid impermeable seal, but also form a substantially rigid unitary structure. Therefore a number of iterations of “stacking” of the plates are possible before any instability issues arise with regard to the unitary structure. By defining one guide plate and one seal plate mated to one another (the first guide plate being previously mated to a multi-well block) as a “stack” assembled by “stacking,” then preferably during iterative chemical or biological processes, the plates are stacked between one and about ten times, more preferably between one and about five times, even more preferably between one and about three times.

As mentioned, when performing iterative chemical or biological processes using successive stacks, the effective volume of the reaction wells is increased. In some instances, it may be desirable to keep the number of “stacks” (supra) to a minimum. In some preferred methods of the invention, when, for example, combinations of liquid-phase and solid-phase chemistry are used, varying combinations of multi-well block, guide plate, seal plate, and receptacle blocks are employed. For example, solid-phase chemistry is used in a method similar to or in correlation with method 100 as described above in relation to FIG. 13. After, for example three, iterative chemical synthetic processes on solid-phase, desired chemical intermediates (e.g. one in each well varying in structure, but having similar chemical reactivity to all other intermediates in all wells) are cleaved from the solid-support and collected in a receptacle block. The receptacle block containing each of the intermediates now functions as a reaction block, for example, for a liquid-phase chemical transformation on the chemical intermediates. Iterative liquid-phase transformations (supra) are performed to synthesize desired products from the intermediates. In this way the flexibility of the invention is further demonstrated, that is, both liquid- and solid-phase chemistries can be performed, either separately or in combinations to provide a wide range of chemical or biological process types.

The invention has been described with respect to particular embodiments and modes of action for illustrative purposes only. The present invention may be subject to many modifications and changes without departing from the spirit or essential characteristics thereof. We therefore claim as our invention all such modifications as come within the scope of the following claims.

1. A seal plate, for substantially stopping fluid communication from a plurality of perforated wells of a multi-well block, or from a plurality of fluid outlets of a guide plate, said seal plate comprising:
a body having an upper major surface and a lower major surface; and
a plurality of sealing elements depending from the upper major surface;
wherein said seal plate is configured to seal said plurality of perforated wells or said plurality of fluid outlets when said upper major surface is registered with said multi-well block or said guide plate, respectively.

2. The seal plate of claim 1, wherein the plurality of perforated wells consists of all wells of the multi-well block.

3. The seal plate of claim 2, wherein said guide plate is configured to establish fluid communication between each of said plurality of perforated wells of said multi-well block and each of said plurality of fluid outlets of said guide plate when said guide plate is registered with said multi-well block.

4. The seal plate of claim 3, wherein each of said sealing elements comprises a well, said well configured to matingly seal either a bottom portion of a corresponding perforated well of said plurality of perforated wells or a corresponding fluid outlet of said plurality of fluid outlets, when said seal plate is registered with said multi-well block or said guide plate, respectively.

5. The seal plate of claim 4, wherein each well of each of said sealing elements comprises an inner surface that circumscribes and forms a first fluid tight seal when mated with either said bottom portion of said corresponding perforated well of said plurality of perforated wells or said corresponding fluid outlet of said plurality of fluid outlets, when said seal plate is registered with said multi-well block or said guide plate, respectively.

6. The seal plate of claim 5, wherein each well of each of said sealing elements comprises:
an orifice defining the opening at the upper portion of;
a first channel depending from the upper major surface of said seal plate; and
a bottom surface, said bottom surface enclosing the bottom portion of said first channel.

7. The seal plate of claim 6, wherein the bottom portion of said first channel depends from said lower major surface of said seal plate.

8. The seal plate of claim 7, further comprising a second channel, said second channel depending from said upper major surface and circumscribing said upper portion of said first channel depending from said upper major surface, wherein a second fluid tight seal is formed when said seal plate is registered, via said upper major surface, with said guide plate whereby the inner surface of said second channel and the outer surface of a lower wall of said guide plate are mated, said lower wall circumscribing said corresponding fluid outlet.

9. The seal plate of claim 6, wherein said bottom surface is perforable by a corresponding protrusion on a second guide plate, when said second guide plate is registered with said lower major surface of said seal plate.

10. The seal plate of claim 6, configured to mate another substantially identical seal plate.

11. The seal plate of claim 6, comprised of at least one of polystyrene, polyethylene, polypropylene, polyvinylidine chloride, polytetrafluoroethylene (PTFE), polyvinyledenefluoride (PVDF), glass-impregnated plastics, and stainless steel.

12. A multi-well assembly, comprising:
a multi-well block having a plurality of wells, each well having a fluid-impermeable bottom surface;
a guide plate defining a plurality of fluid passageways, each fluid passageway corresponding to a respective well of the multi-well block, the guide plate being configured such that, whenever the guide plate is registered with the multi-well block, fluid communication is established between each well and an associated fluid passageway; and each of said plurality of fluid passageways having a fluid outlet; and
a seal plate, said seal plate have a plurality of sealing elements, each of said sealing elements corresponding to each outlet of said plurality of fluid passageways;
wherein registration of the seal plate with the guide plate substantially stops fluid communication from each outlet of said plurality of fluid passageways.

13. The multi-well assembly of claim 12, wherein each of said plurality of sealing elements comprises a substantially fluid-impermeable well.

14. The multi-well assembly of claim 13, wherein the guide plate is also configured such that, whenever another substantially identical guide plate is registered with the seal plate, fluid communication is established between each well of said plurality of sealing elements and the associated fluid passageway of said another substantially identical guide plate.

15. A method of performing iterative chemical or biological processes in a multi-well block, the method comprising:
a) performing a first chemical or biological process in a plurality of wells of the multi-well block;
b) perforating a lower portion of each of the plurality of wells of the multi-well block;
c) removing, via the perforated lower portion of each of said plurality of wells of the multi-well block, a first fluid portion of the contents of each of the plurality of wells of the multi-well block, while a first solid portion of the contents of each of the plurality of wells of the multi-well block remains;
d) sealing the plurality of wells of the multi-well block; and
e) performing a second chemical or biological process in the plurality of wells of the multi-well block.

16. The method of claim 15, wherein perforating a lower portion of the plurality of wells of the multi-well block is accomplished via registration of a first guide plate with said multi-well block.

17. The method of claim 16, wherein sealing the plurality of wells of the multi-well block is accomplished via registration of a first seal plate with said first guide plate.

18. The method of claim 17, further comprising:
f) perforating, via registration of a second guide plate with said first seal plate, a lower portion of a plurality of wells of the first seal plate after performing said second chemical or biological process in the plurality of wells of the multi-well block; wherein said plurality of wells of the first seal plate correspond to the first plurality of wells of the multi-well block.

19. The method of claim 18, further comprising:
g) removing, via the perforated lower portion of each of said plurality of wells of the first seal plate, a second fluid portion of the contents of each of the plurality of wells of the multi-well block; while a second solid portion of the contents of each of the plurality of wells of the multi-well block remains;
h) sealing said plurality of wells of the multi-well block; and
i) performing a third chemical or biological process in the plurality of wells of the multi-well block.

20. The method of claim 19, wherein h) comprises registration of a second seal plate with said second guide plate.

21. The method of claim 20, wherein the plurality of wells of the multi-well block consists of all the wells of the multi-well block.

22. A method of performing iterative chemical or biological processes, the method comprising:
a) performing a first chemical or biological process in a plurality of wells of a first multi-well block;
b) perforating a lower portion of each of the plurality of wells of the first multi-well block;
c) removing, via the perforated lower portion of each of said plurality of wells of the first multi-well block, a first fluid portion of the contents of each of the plurality of wells of the first multi-well block, while a first solid portion of the contents of each of the plurality of wells of the first multi-well block remains;
d) sealing the plurality of wells of the first multi-well block;
e) performing a second chemical or biological process in the plurality of wells of the first multi-well block;
f) unsealing the plurality of wells of the first multi-well block;
g) removing, via the perforated lower portion of each of said plurality of wells of the multi-well block, a second fluid portion of the contents of each of the plurality of wells of the first multi-well block, while a second solid portion of the contents of each of the plurality of wells of the first multi-well block remains;
h) sealing the plurality of wells of the first multi-well block;
i) dissolving the second solid portion of the contents of each of the plurality of wells of the first multi-well block in a solvent to make a solution in each of the plurality of wells of the first multi-well block;
j) transferring, substantially, said solution from each of the plurality of wells of the first multi-well block to each of a corresponding well of a plurality of wells of a second multi-well block, via each perforation in said lower portion of each of said plurality of wells of the first multi-well block; and
k) performing a third chemical or biological process in the plurality of wells of the second multi-well block.

23. The method of claim 22, wherein a plurality of guide plates and a plurality of seal plates is used to perform said method.
